(19) United States
(12) Patent Application Publication
(10) Pub. No.: US 2026/0045433 A1
(43) Pub. Date: Feb. 12, 2026

(54) DIGITAL CONTROL FOR CIRCUIT BREAKERS

(71) Applicant: Schneider Electric USA, Inc., Andover, MA (US)

(72) Inventor: John Shea, Wake Forest, NC (US)

(73) Assignee: Schneider Electric USA, Inc., Andover, MA (US)

(21) Appl. No.: 18/800,669

(22) Filed: Aug. 12, 2024

(51) Int. Cl. H01H 50/18; H01H 47/22; H01H 50/02; H01H 50/54

(52) U.S. Cl. CPC H01H 50/18; H01H 47/22; H01H 50/02; H01H 50/54

(57) ABSTRACT

A system includes a circuit breaker and a switching module with a first module terminal for electrically connecting the switching module to an electrical circuit, and a second module terminal connected in electrical series with a first terminal of the circuit breaker. A switching device of the switching module is connected in electrical series between the first and second module terminals and is configured to switch between an ON state for allowing electrical current through the electrical circuit and an OFF state for opening the electrical circuit to stop current flow therethrough. The circuit breaker has a first housing that houses the breaker mechanism therein. The switching module has a second housing that houses the switching device therein. The second housing can be mounted to the first housing. The first and second housings together can be configured to fit in a physical envelope of a molded case circuit breaker (MCCB).

### BACKGROUND

### 1. Field

This disclosure relates to circuit breakers, and more particularly to digital and/or remote control of circuit breakers.

### 2. Description of Related Art

Motor operators can be added to the front of a circuit breaker to remotely operate the breaker mechanism. Breaker and contactors are used together to form a motor starter for control of a load in conventional configurations. In these configurations, the additional contactor is large, and the contactor is destroyed after a short-circuit fault and must be replaced. Solid-state breakers could also be used are not always suitable for all applications.

Such conventional methods and systems have generally been considered satisfactory for their intended purpose. However, there is still a need in the art for improved circuit breaker control. The present disclosure provides a solution for this need.

### SUMMARY

A system includes a switching module with a first module terminal for electrically connecting the switching module to an electrical circuit, and a second module terminal configured to connect in electrical series with a first terminal of a circuit breaker. A switching device of the switching module is connected in electrical series between the first and second module terminals and is configured to switch between an ON state for allowing electrical current through the electrical circuit and an OFF state for opening the electrical circuit to stop current flow therethrough.

The switching module can have a module housing that houses the switching device. The switching device can include a first contact electrically connected to the first module terminal. A second contact can be electrically connected to the second module terminal. A third contact can be electrically connected to an arm that is mounted in the second housing for rotation relative to the housing around a pivot axis. A fourth contact can be electrically connected to the arm. In the ON state, the arm can be pivoted to a first position relative to the second housing with the first and third contacts electrically connected to one another, and with the second and fourth contacts electrically connected to one another for electrically connecting the first module terminal to the second module terminal through and electrical path that includes the arm and the first, second, third, and fourth contacts. In the OFF state, the arm can be pivoted to a second position relative to the second housing with the first and third contacts spaced apart from one another, and with the second and fourth contacts spaced apart from one another to break open the electrical path so the first and second module terminals are not electrically connected in the OFF state.

The second and third contacts can be on opposite sides of the arm. The third contact can be closer to the rotation axis than is the fourth contact. A first plurality of arc chutes can be included proximate the first and third contacts and a second plurality of arc chutes can be included proximate the second and fourth contacts.

An actuator can be operatively connected to pivot the arm back and forth among the first and second positions. The actuator can include a solenoid that is operatively connected to an input output connector of the switching module for wired and/or wireless control of the ON and OFF states of the switching module.

The solenoid can include a bistable mechanism including an actuator body mounted to the module housing. An armature can be mounted in the actuator body for sliding back and forth within the armature along an armature axis between a first bistable position and a second bistable position. The armature can include a ferromagnetic material. A biasing member can be mounted to the armature and to the actuator body configured to bias the armature to a position between the first and second bistable positions. A first magnet can be mounted at a first end of the actuator body, configured to magnetically latch the armature in the first bistable position. A first solenoid coil can be included proximate the first magnet, configured to cancel, at least partially, a magnetic field of the first magnet with the first solenoid energized to allow the biasing member to move the armature away from the first bistable position. A second magnet can be mounted at a second end of the actuator body opposite the first end, configured to magnetically latch the armature in the second bistable position. A second solenoid coil can be included proximate the second magnet, configured to cancel, at least partially, a magnetic field of the second magnet with the second solenoid energized to allow the biasing member to move the armature away from the second bistable position. Magnetic poles of the first magnet can be positioned along the armature axis. Magnetic poles of the second magnet can be positioned along the armature axis, and unlike poles of the first and second magnets can be oriented toward one another and toward a middle position along the armature axis between the first and second magnets.

The armature can extend adjacent to or through an aperture of the first terminal to the arm. A contact spring can be included between the arm and first terminal, disposed circumferentially around a portion of the armature between the first terminal and the arm.

The arm can include a plurality of laminations of alternating first and second materials. Each of the laminations can be oriented in a plane perpendicular to the rotation axis. The first material can include copper. The second material can be less electrically conductive than copper and can be harder than copper. The plurality of laminations can include one or more laminations of a third material. One or more pins can extend through the plurality of laminations to secure the plurality of laminations together.

In another arm configuration, a portion of the first terminal in electrical contact with first contact of the first terminal can include a first material. A portion of the first terminal backing the first terminal opposite the first contact can include a second material. A portion of the arm in electrical contact with the third and fourth contacts can include the first material. A backing portion of the arm opposite the second contact can include the second material. The rotation axis can be through the second material of the arm.

A circuit breaker can have a first breaker terminal electrically connected to the second terminal of the switching module. A second breaker terminal of the circuit breaker can be included for electrically connecting a circuit breaker mechanism of the circuit breaker to the electrical circuit. The breaker mechanism can have an ON state for allowing current flow through the electrical circuit and an OFF state for opening the electrical circuit to stop current flow therethrough. The circuit breaker can have a first housing that houses the breaker mechanism therein. The switching module can have a second housing separate from the first housing. The second housing can house the switching device therein, and the second housing can be mounted to the first housing. The first and second housings can be mounted together fit in a physical envelope of a molded case circuit breaker (MCCB).

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic side elevation view of an embodiment of a system constructed in accordance with the present disclosure, showing the switching module mounted to the circuit breaker;

FIG. 2 is a schematic side elevation view of the switching module of FIG. 1, showing the arm and actuator of the switching device;

FIG. 3 is a schematic front elevation view of the arm of FIG. 2, showing the laminations;

FIG. 4 is a schematic side elevation view of the arm of FIG. 3, showing the rotation axis for the pivot;

FIG. 5 is a schematic front elevation view of the arm of FIG. 2, showing another lamination configuration;

FIG. 6 is a schematic side elevation view of the arm of FIG. 5, showing the rotation axis for the pivot;

FIG. 7 is a schematic side elevation view of the switching module of FIG. 1, showing another configuration of the arm and one of the terminals; and

FIG. 8 is a schematic side elevation view of a portion of the system of FIG. 1, showing the bistable, bidirectional actuator of the switching device.

### DETAILED DESCRIPTION OF THE PREFERRED EMBODIMENTS

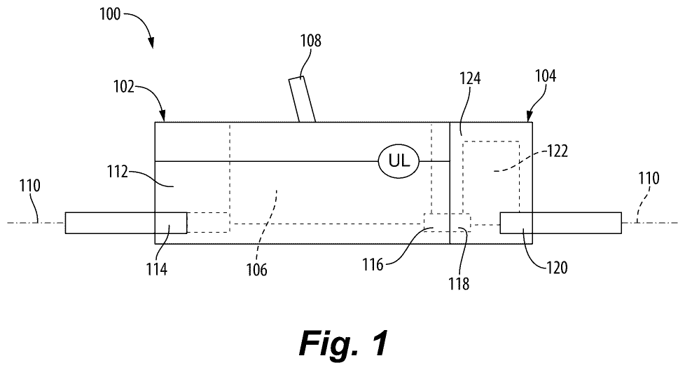

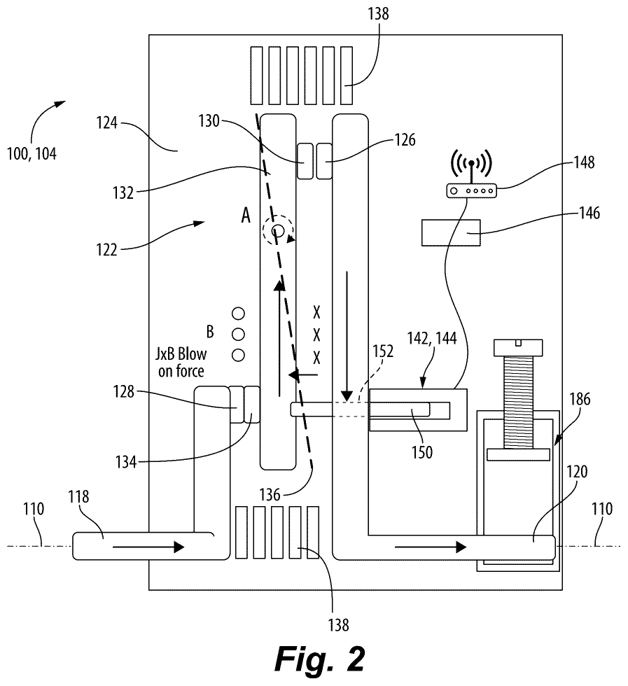

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-8, as will be described. The systems and methods described herein can be used to provide digital and remote ON/OFF control of electrical circuits that can be used with mechanical circuit breaker mechanisms for new installations or retrofits.

The system 100 includes a circuit breaker 102 and a switching module 104. A circuit breaker mechanism 106 of the circuit breaker 102 includes a switch handle 108 for manually switching the electrical circuit in a circuit 110 between ON and OFF states and for resetting after a fault trips the circuit breaker mechanism 106. The breaker mechanism 106 has an ON state for allowing current flow through the electrical circuit 110 and an OFF state for opening the electrical circuit to stop current flow therethrough. The circuit breaker has a first housing 112 that houses the breaker mechanism 106 therein. The circuit breaker 102 has one breaker terminal 114 for connecting the breaker mechanism 106 electrically to the circuit 110, and another breaker terminal 116 electrically connected to breaker mechanism 106 and to a terminal 118 of the switching module 104.

The switching module 104 has a module terminal 120 for electrically connecting a switching device 122 of the switching module 104 to the electrical circuit 110. The module terminal 120 can include a wire connector lug 186. The module terminal 118 connects the switching device 122 in electrical series with terminal 116 of the circuit breaker 102. The switching device 122 of the switching module 104 is therefore connected in electrical series with the breaker mechanism 106 and can switch between an ON state for allowing electrical current through the electrical circuit 110, as long as the breaker mechanism 106 is in the ON position, and an OFF state for opening the electrical circuit 110 to stop current flow therethrough.

The switching module 104 has housing 124 separate from the housing 112 of the circuit breaker 102. The housing 124 houses the switching device 122 therein. The module housing can be made separately and can be mounted to the circuit breaker housing 112 as shown in FIG. 1. The housings 112, 124 mounted together can be configured to fit in the physical envelope of a molded case circuit breaker (MCCB), e.g., for use in standard breaker panels.

With reference now to FIG. 2, the switching device 122 of the switching module 104 includes a contact 126 electrically connected to the module terminal 120. A contact 128 is electrically connected to the module terminal 118. A contact 130 is electrically connected to an arm 132 that is mounted in the module housing 124 for rotation relative to the housing 124 around a pivot axis A. A contact 134 is electrically connected to the arm 132 at an end of the arm 132 opposite from the contact 130. The contacts 130, 134 are on opposite sides of the arm 132, and on opposite ends of the arm relative to the rotation axis A. The contact 130 is closer to the rotation axis A than is the contact 134.

In the ON state of the switching module 104, the arm 132 is pivoted to a first position as shown in FIG. 2 relative to the module housing 124 with the contacts 126, 130 electrically connected to one another, and with the contacts 128, 134 electrically connected to one another for electrically connecting the module terminal 118 to the module terminal 120 through and electrical path indicated by the long arrows in FIG. 2 that includes the arm 132, the contacts 126, 128, 130, 134. In the OFF state, the arm 132 is pivoted to a second position, indicated in FIG. 2 with the broken line 136, relative to the module housing 124, which spaces contacts 126, 130 apart from one another, and spaces the contacts 128, 134 apart from one another to break open the electrical path so the module terminals 118, 120 are not electrically connected in the OFF state. Having two sets of contacts 126, 130 and 128, 134 that must both close to complete the circuit 110 helps preserve the contacts 126, 128, 130, 134 during arc events and allows for this design geometry. A first plurality of arc chutes 138 is included in the housing 124 proximate the contacts 126, 130 and a second plurality of arc chutes 140 are included in the housing 124 proximate the contacts 128, 134.

An actuator 142 is operatively connected to pivot the arm 132 back and forth about the axis A among the first and second positions. The actuator 142 includes a solenoid 144 that is operatively connected, e.g., through a controller 146 of the switching module 104 to an input output connector 148 of the switching module for wired and/or wireless control of the ON and OFF states of the switching module 104. The armature 150 of the solenoid 144 extends through an aperture 152 of the terminal 120 to the arm 132. It is also contemplated that the solenoid 144 can be offset, e.g. into or out of the viewing plane in Fig. X, relative to the terminal 120 so that the armature 150 extends adjacent to the terminal 120 and connects to the arm 132.

When electrical current is conducted through the arm 132 and the terminal 120, a magnetic field is generated around the arm 132 and around the terminal 120. The field around the arm 132 is identified in FIG. 2 with the three circles labeled B, and the three X's, wherein the B circles indicate field lines out of the viewing plane, and the X's represent field lines going into the viewing plane. The force from the magnetic field is in a direction determined by the cross product of J cross B, which force is referred to herein as a blow on force, which tends to increase the contact force between the contacts 128, 134 and between the contacts 126, 130. The large gray arrow shows this blow on force, where J is the current density in the contact/arms 132 and 120 located along the parallel lengths between the pair of contacts 128, 134 and the pivot point A.

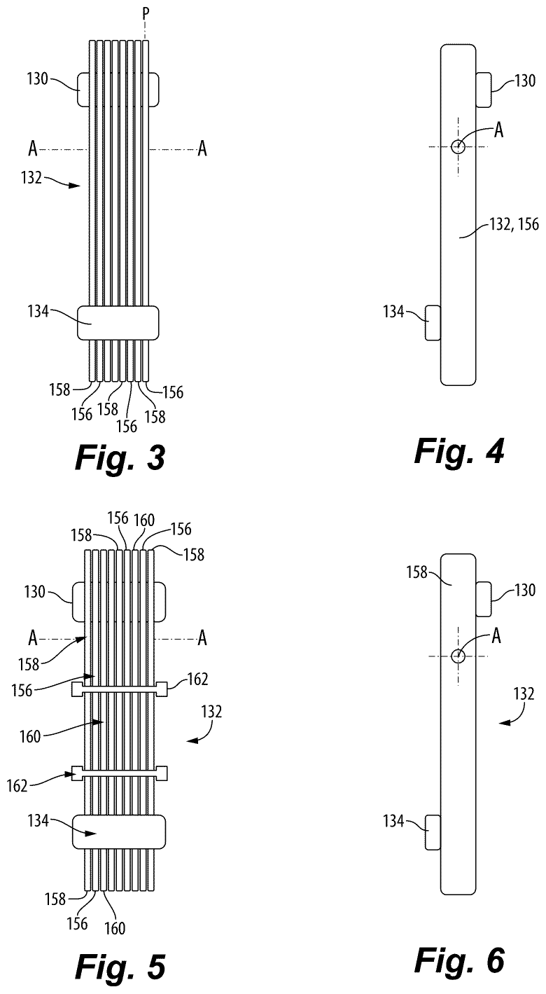

With reference now to FIG. 3, good electrical conduction is desired through the arm 132, however conductive materials like copper tend to be easily deformed. The pivot location of axis A in the arm 132 determines holding force during short-circuit events. The closer the axis A is to the upper contact pair 126, 130, the higher the blow-on force due to the increased moment arm, but the lower the contact gap. For specific applications, the pivot location can therefore be optimized. Magnetic forces, generated by the fault current and the conductor geometry keep the moving arm 132 and its contacts 130, 134 closed during a short-circuit event. Choice of contact material and the number of contacts and moving arms 132 in parallel can be chosen for a desired steady-state current rating, e.g., larger breaker ratings may use multiple contact fingers for each contact 126, 128, 130, 134 to maintain desired temperature rise.

The blow on force during an arc fault may exceed the material strength of a purely copper arm 132, for example. The arm 132 includes a plurality of laminations of alternating first and second materials 156, 158. Each of the laminations is oriented in a respective plane, e.g., plane P is shown in FIG. 3 for one of the laminations, perpendicular to the rotation axis A. The first material 156 can include a copper material, e.g., a silver bearing copper, wherein the second material 158 may be less electrically conductive than the copper material, but is harder than the copper material, e.g., a nickel-chromium super alloy of stainless steel. FIG. 4 shows the arm 132 in elevation for reference relative to FIG. 3 for the positions of the contacts 130, 134 and axis A. FIGS. 5 and 6 show the same views of the arm 132 as FIGS. 3 and 4, respectively, but for a configuration wherein the plurality of laminations includes one or more laminations of a third material 160 in an alternating pattern with laminations of the first and second materials 156, 158. Specifically, the third material is shown between two laminations of the first material 156, and the combined lamination of the first and third materials 156, 160 alternates with laminations of the second material 158. The third material 160 can be a polymer. One or more pins 162 can extend through the plurality of laminations to secure the plurality of laminations together. The laminations in FIGS. 3-6 provide the electrical conductivity needed for the arm 132 as well as the strength against bending under the blow on forces described above.

High strength is beneficial for the conductor arm 132 due to the magnetic forces that can be created during a fault that will tend want to bend the arm 132. A ferromagnetic steel for the second material 158 has the added benefit of enhancing the magnetic field. The arm 132 can be manufactured by bonding layers using induction brazing, ultra-sonic welding, 3D manufacturing process, or the like. It is also contemplated that the laminations can be pinned together as in FIGS. 5-6. Alternating ferromagnetic and non-ferromagnetic high strength materials can be employed to compress the arm 132 during a short-circuit event.

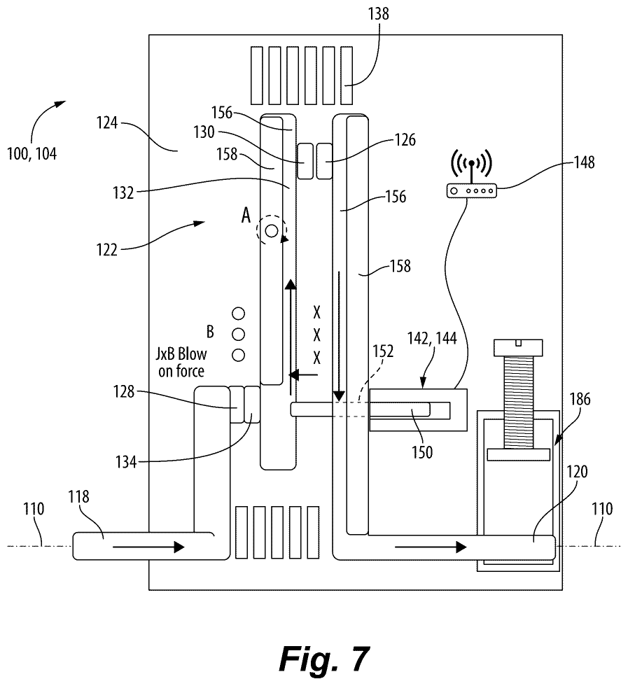

With reference now to FIG. 7, in another configuration of the arm 132, A portion of the arm 132 in electrical contact with the third and fourth contacts 130, 134 includes the first material 156, e.g., a copper material, for electrical conductivity. A backing portion of the arm 132 opposite the contact 128 includes the second material 158, e.g., a ferromagnetic alloy of steel, a superalloy of stainless steel, or the like, for strength against the blow on forces. Similarly, a portion of the terminal 120 in direct electrical contact with the contact 126 includes the first material 156, e.g., a copper material for electrical conductivity. A portion of the terminal 120 backs the first terminal 120 opposite the contact 126 includes a second material 158 for strength against the blow on forces. The rotation axis A in this configuration passes through the second material 158 of the arm 132 (noting that the material 158 in FIG. 7 is of different construction from that shown in FIGS. 3-6).

Bonding a high yield strength material 158 as a support to the conductive material 156 of the arm as shown, helps prevent the arm 132 (and similarly the terminal 120) from yielding during short-circuit events. The second material 158 can be non-magnetic (e.g., 304, 316 stainless steels, titanium, precipitation hardened aluminum, nickel-chromium-based superalloy. Using a high yield strength ferromagnetic material (e.g., carbon steels) for the second material 158 can enhance magnetic holding force during a short-circuit interruption. For the first material 156, sufficient conductor thickness is needed for thermal requirements. Using a silver bearing copper can also improve strength if necessary.

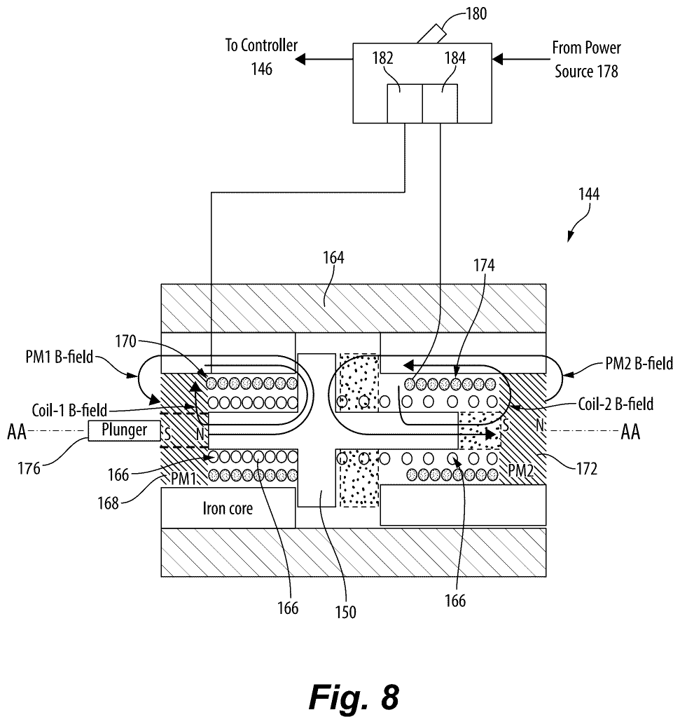

With reference now to FIG. 8, the solenoid 144 includes a bistable mechanism including an actuator body 164 mounted to the module housing 124 of FIG. 2. An armature 150 is mounted in the actuator body 164 for sliding back and forth within the armature along an armature axis AA between a first bistable position shown in FIG. 8 and a second bistable position, indicated schematically in FIG. 8 with the stippling. The armature 150 includes a ferromagnetic material. A biasing member 166, e.g., a spring or set of springs, is mounted to the armature 150 and to the actuator body 164 and is configured to bias the armature 150 to a position between the first and second bistable positions, e.g., to center the armature 150. A first permanent magnet 168 is mounted at a first end of the actuator body 164, configured to magnetically latch the armature 150 in the first bistable position as shown in FIG. 8. A first solenoid coil 170 is proximate the first magnet 168, and is configured, when energized with a current pulse, to generate a magnetic field (Coil-1 B-field) to at least partially cancel a magnetic field (PM1 B-field) of the first magnet 168 to allow the biasing member 166 to move the armature 150 away from the first bistable position, where the magnetic field (PM2 B-field) described below can pull the armature toward the second position indicated with the stippling in FIG. 8.

A second permanent magnet 172 is mounted at a second end of the actuator body 164 opposite the first end, configured to magnetically latch the armature 150 in the second bistable position indicated with stippling in FIG. 8. A second solenoid coil 174 is included proximate the second magnet 172. The second solenoid coil 174 is configured, when energized with a current pulse, to generate a magnetic field (Coil-2 B-field) that at least partially cancels the magnetic field (PM2 B-field) of the second magnet 172 to allow the biasing member 166 to move the armature 152 away from the second bistable position shown in stippling in FIG. 8, where the magnetic field of the first permanent magnet 168 (PM1 B-field) can pull the armature 150 toward the first position as shown in FIG. 8. The coils 170, 174 can be energized to assist their respective permanent magnets 168, 172 in pulling the armature 150 toward their respective ends of the actuator body 164. Coil control can be initiated by direct wiring to a power source 178 and a manual switch 180 to energize the coils 170, 174. It is also contemplated that a respective solid-state switch 182, 184 could be employed to energize the respective coils 170, 174, e.g., based on commands from the controller 146, which can be controlled by a wired or wireless signal received form an external controller. The field lines for PM1, Coil-1, PM2, and Coil-2 B-fields are shown schematically, wherein only one side of each field line is shown, and not all possible field line paths are shown for sake of clarity.

Magnetic poles N, S of the first magnet 168 are positioned along the armature axis AA. Magnetic poles N, S of the second magnet 172 are also positioned along the armature axis AA. Unlike poles N, S of the first and second magnets 168, 172 are oriented toward one another and toward a middle position along the armature axis AA between the first and second magnets 168, 172. The plunger 176 of the armature 150 passes through an aperture in the first magnet 168 to be mechanically connected to the arm 132 as shown in FIGS. 2 and 7. This actuator arrangement provides a bi-directional solenoid, based on toggling a plunger 176 between two permanent magnets 168, 172 and allows for opening and closing of the switching device 122, labeled in FIGS. 1-2. Those skilled in the art will readily appreciate that any other suitable mechanism can be used without departing from the scope of this disclosure.

Systems and methods as disclosed herein provide potential benefits including the following. Add-on module is used for remote control of an MCCB. The MCCB breaker mechanism does not operate for remote or digital control, but rather a set of series contacts makes and breaks the load current. The small package size and the ability to withstand short-circuit events without contact damage can replace motor operators, motor-starter combinations, and can be an alternative to solid-state circuit breakers. Demand load management can be implemented allowing New Energy Landscape (NEL) architectures. Conductor geometry can enable the switching device to withstand high current and still be able to operate the contacts to open/close under steady-state conditions. A bidirectional solenoid enables switch operation either locally or remotely. A blow-on geometry coupled with a bi-directional solenoid in a small package size can be used as an add-on module to existing circuit breakers such as MCCB's. This allows for existing products to be utilized in for digital applications which require on demand operation of loads (e.g., NEL architectures). The switching module can be an add-on module that fits the cross-section of an MCCB—not changing existing enclosure dimensions. Existing UL labels for MCCB's would not need to change because the combined system retains all existing MCCB protection.

The methods and systems of the present disclosure, as described above and shown in the drawings, provide for digital and remote ON/OFF control of electrical circuits that can be used with mechanical circuit breaker mechanisms for new installations or retrofits. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A system comprising:
a switching module with a first module terminal for electrically connecting the switching module to an electrical circuit, and a second module terminal configured to connect in electrical series with a first terminal of a circuit breaker, wherein a switching device of the switching module is connected in electrical series between the first and second module terminals and is configured to switch between an ON state for allowing electrical current through the electrical circuit and an OFF state for opening the electrical circuit to stop current flow therethrough.

2. The system as recited in claim 1, wherein the switching module has a module housing that houses the switching device.

3. The system as recited in claim 2, wherein the switching device includes:
a first contact electrically connected to the first module terminal;
a second contact electrically connected to the second module terminal;
a third contact electrically connected to an arm that is mounted in the second housing for rotation relative to the housing around a pivot axis; and
a fourth contact electrically connected to the arm,
wherein in the ON state, the arm is pivoted to a first position relative to the second housing with the first and third contacts electrically connected to one another, and with the second and fourth contacts electrically connected to one another for electrically connecting the first module terminal to the second module terminal through and electrical path that includes the arm and the first, second, third, and fourth contacts, and
wherein in the OFF state, the arm is pivoted to a second position relative to the second housing with the first and third contacts spaced apart from one another, and with the second and fourth contacts spaced apart from one another to break open the electrical path so the first and second module terminals are not electrically connected in the OFF state.

4. The system as recited in claim 3, further comprising an actuator operatively connected to pivot the arm back and forth among the first and second positions.

5. The system as recited in claim 4, wherein the actuator includes a solenoid that is operatively connected to an input output connector of the switching module for wired and/or wireless control of the ON and OFF states of the switching module.

6. The system as recited in claim 5, wherein the solenoid includes a bistable mechanism including:
an actuator body mounted to the module housing;
an armature mounted in the actuator body for sliding back and forth within the armature along an armature axis between a first bistable position and a second bistable position, wherein the armature includes a ferromagnetic material;
a biasing member mounted to the armature and to the actuator body configured to bias the armature to a position between the first and second bistable positions;
a first magnet mounted at a first end of the actuator body, configured to magnetically latch the armature in the first bistable position;
a first solenoid coil proximate the first magnet, configured to cancel, at least partially, a magnetic field of the first magnet with the first solenoid energized to allow the biasing member to move the armature away from the first bistable position;
a second magnet mounted at a second end of the actuator body opposite the first end, configured to magnetically latch the armature in the second bistable position; and
a second solenoid coil proximate the second magnet, configured to at least partially cancel a magnetic field of the second magnet with the second solenoid energized to allow the biasing member to move the armature away from the second bistable position.

7. The system as recited in claim 6, wherein magnetic poles of the first magnet are positioned along the armature axis, wherein magnetic poles of the second magnet are positioned along the armature axis, and wherein unlike poles of the first and second magnets are oriented toward one another and toward a middle position along the armature axis between the first and second magnets.

8. The system as recited in claim 6, wherein the armature extends adjacent to or through an aperture of the first terminal to the arm.

9. The system as recited in claim 6, further comprising a contact spring between the arm and first terminal, disposed circumferentially around a portion of the armature between the first terminal and the arm.

10. The system as recited in claim 3, wherein the second and third contacts are on opposite sides of the arm.

11. The system as recited in claim 3, wherein the third contact is closer to the rotation axis than is the fourth contact.

12. The system as recited in claim 3, wherein the arm includes a plurality of laminations of alternating first and second materials, wherein each of the laminations is oriented in a plane perpendicular to the rotation axis.

13. The system as recited in claim 12, wherein the first material includes copper, wherein the second material is less electrically conductive than copper, and wherein the second material is harder than copper.

14. The system as recited in claim 13, wherein the plurality of laminations includes one or more laminations of a third material, wherein one or more pins extend through the plurality of laminations to secure the plurality of laminations together.

15. The system as recited in claim 3, wherein a portion of the first terminal in electrical contact with first contact of the first terminal includes a first material, wherein a portion of the first terminal backing the first terminal opposite the first contact includes a second material, wherein a portion of the arm in electrical contact with the third and fourth contacts includes the first material, and wherein a backing portion of the arm opposite the second contact includes the second material.

16. The system as recited in claim 15, wherein the rotation axis is through the second material of the arm.

17. The system as recited in claim 3, further comprising a first plurality of arc chutes proximate the first and third contacts and a second plurality of arc chutes proximate the second and fourth contacts.

18. The system as recited in claim 1, further comprising:
a circuit breaker with a first breaker terminal electrically connected to the second terminal of the switching module and a second breaker terminal for electrically connecting a circuit breaker mechanism of the circuit breaker to the electrical circuit, wherein the breaker mechanism has an ON state for allowing current flow through the electrical circuit and an OFF state for opening the electrical circuit to stop current flow therethrough.

19. The system as recited in claim 18, wherein the circuit breaker has a first housing that houses the breaker mechanism therein, and wherein the switching module has a second housing separate from the first housing, wherein the second housing houses the switching device therein, and wherein the second housing is mounted to the first housing.

20. The system as recited in claim 19, wherein the first and second housings mounted together fit in a physical envelope of a molded case circuit breaker (MCCB).
